(19) United States
(12) Patent Application Publication
(10) Pub. No.: US 2005/0001392 A1
(43) Pub. Date: Jan. 6, 2005

(54) Tramp board

(76) Inventor: Scott Walter, Jamestown, NY (US)

Correspondence Address: THE BILICKI LAW FIRM, PC, 1285 North Main Street, JAMESTOWN, NY, 14701, US

(21) Appl. No.: 10/612,687

(22) Filed: Jul. 1, 2003

(51) Int. Cl. B62B 15/00

(52) U.S. Cl. 280/14.21

(57) ABSTRACT

The present invention is a board that aids in performing acrobatics and stunts on a trampoline. The board is curved up from a horizontal plane at each end, forming a shallow and elongated U-shape, and is made of lightweight, flexible material. The board has at least one securing member adapted to receive a user's feet.

### FIELD OF THE INVENTION

The present invention relates generally to a device used on a trampoline. Specifically, the invention relates to a board for playing or performing acrobatics on a trampoline.

### BRIEF DESCRIPTION OF THE DRAWINGS

FIG. 1 shows a perspective front view of one embodiment of the invention.

FIG. 2 shows a side view of one embodiment of the invention.

FIG. 3 shows one embodiment of the invention in use.

### DETAILED DESCRIPTION OF EMBODIMENTS OF THE INVENTION

For the purpose of promoting an understanding of the present invention, reference will be made to embodiments of the invention, as illustrated in the figures. It will nevertheless be understood that no limitations on the scope of the invention are thereby intended. Such alterations as changing the geometry of the invention or changing the placement of the securing members (i.e., the mechanism for holding a user's feet in place) or the material of the parts of the board are alterations, which are intended to come within the spirit and scope of the invention. Moreover, with particular reference to the figures, the reader should understand that like numerals in the various figures refer to the same elements of the embodiment.

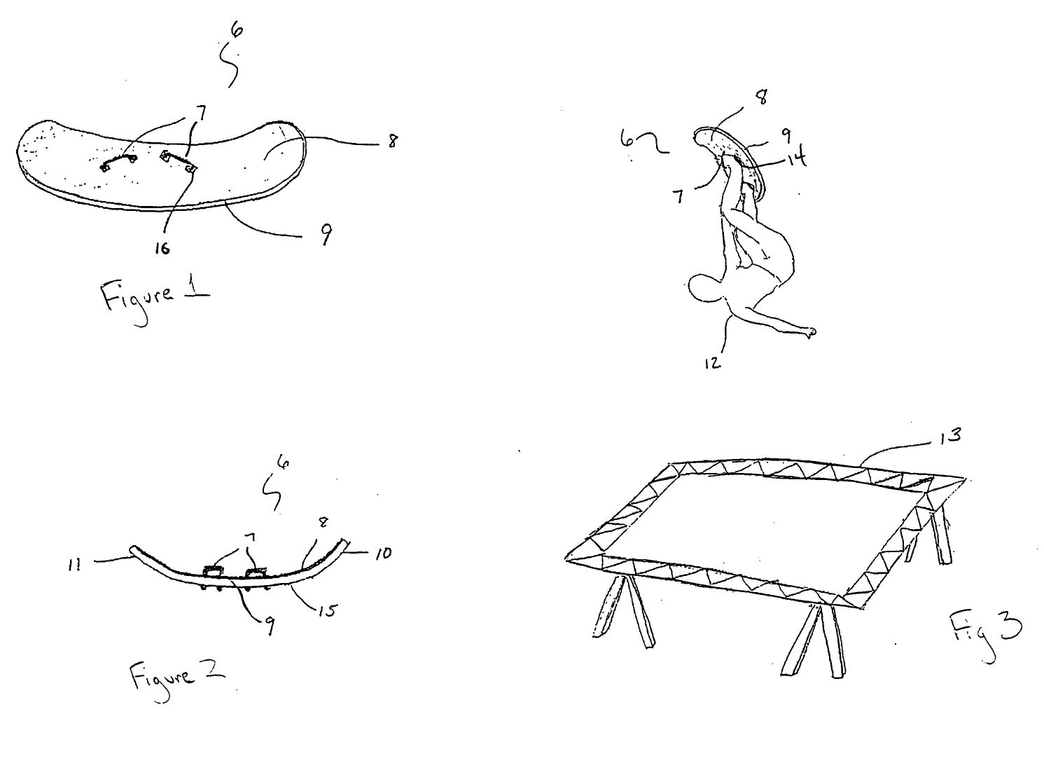

FIG. 1 shows a perspective front view of one embodiment of the invention. Board 6, in the embodiment shown, is made of a foam material which is lightweight, durable, and flexible. One of ordinary skill in the art will readily appreciate that other lightweight, durable, and/or flexible materials, such as polyurethane, could be used to construct board 6. Moreover, in the embodiment shown in FIG. 1, board 6 is constructed in a substantially ovular shape. However, one of ordinary skill in the art will readily appreciate that board 6 could be constructed in a wide variety of shapes. By way of example and not limitation, the device could be generally circular, rectangular (with or without rounded edges), hexagonal, or elliptical, as long as the edges are not sharp so as to avoid damaging the trampoline.

In the embodiment of FIG. 1, top surface 9 of board 6 is covered by a non-slip gripping layer 8 and allows the user's feet to avoid slipping. In this embodiment, non-slip gripping layer 8, which is pliable and soft to the touch, is attached to top surface 9 with an adhesive. One of ordinary skill in the art will readily recognize that other means of attachment could be used to securely fix non-slip gripping layer 8 to top surface 9 of board 6. In another embodiment, board 6 is constructed of a non-slip material, thereby making the adhesion of a non-slip gripping layer unnecessary.

Referring further to the embodiment depicted in FIG. 1, board 6 is further comprised of two adjustable securing members 7, which are attached to non-slip gripping layer 8 on top surface 9 of board 6. The material chosen for securing members 7 should provide strength and flexibility so as not to break or pinch the feet when in use, as well as absorb the impact of the trampoline, e.g., a rubber or rubber-like material. Other materials from which to make securing members 7 of include, but are not limited to, plastics, leather, foam, and nylon or other synthetic materials. Moreover, securing members 7 include an adjustment mechanism such as straps with a buckle, a stretchable material, a hook-and-loop mechanism, or any other means known to those of ordinary skill in the art to provide adjustability to accommodate various sizes of a user's feet.

Furthermore, although not shown in FIG. 1, securing members 7 can include a second securing member, a heel securing member, that holds the heel in place to provide additional support for the user's feet. In one embodiment, securing members 7 each include a heel securing member parallel to and spaced behind each securing member 7. The heel securing member (visible in FIG. 3) is typically made of the same material as the front securing member, but can be of another material. The heel securing member is secured to board 6 by any of the means used to attach securing members 7 to board 6, discussed infra. In addition, because of it's relatively short length, the heel securing member may or may not have an adjustment mechanism.

In an alternate embodiment, securing member 7 is a single band that is long enough and is secured to board 6 wide enough to allow both of the user's feet to be secured between it and board 6. The single securing member is constructed of materials and with the same characteristics as securing members 7, described supra.

One of ordinary skill in the art will readily appreciate that adjustable securing members 7 could be secured to top surface 9 of board 6 using as little as one attachment for each securing member 7. In one embodiment, securing members 7 are attached to board 6 by feeding each end of each securing member 7 through non-slip gripping layer 8 and board 6 (or just board 6 if board 6 is constructed of a non-slip material), and tying securing member 7 off on the bottom side of board 6. In an alternate embodiment, the bottom (not shown) of board 6 has a recess for each end of securing members 7 so that the ends do not protrude from the bottom of board 6. An alternate attachment mechanism for attaching securing members 7 to board 6 is through the use of a screw. However, if a screw is used to attach securing members 7 to board 6, the screw should not protrude from the bottom of board 6 so as to avoid damaging the trampoline when in use. In an embodiment in which the screw does protrude, the protruding portion of the screw can be covered with a smooth covering known to one of ordinary skill in the art so as to prevent damaging the trampoline.

In the embodiment of FIG. 1, holes 16 are present on non-slip gripping layer 8 and board 6 to allow the passing of each end of securing member 7 to the bottom portion of board 6 in order to allow a user to secure their feet to board 6. In one alternate embodiment, securing member penetrates only non-slip gripping layer 8, but before it is secured to board 6, such that the portion of securing member that protrudes beyond non-slip gripping layer 8 would be sandwiched between board 6 and non-slip gripping layer 8. In a variation of this embodiment, board 6 has a recess to accommodate the that portion of securing member 7 that protrudes beyond non-slip gripping layer 8 so as to provide a smooth joining of board 6 and non-slip gripping layer 8. However, if board 6 is constructed of a non-slip material, the holes that allow securing members 7 to penetrate board 6 and be tied off at the bottom surface would penetrate the entire thickness of board 6.

Alternatively, securing members 7 are adjustable straps, allowing multiple users to use the same board 6 by merely adjusting securing members 7 to fit their own feet. Moreover, as can be seen in the embodiment of FIG. 1, securing members 7 are arranged at an angle relative to one another in order to allow the user to maintain balance when using board 6. However, securing members 7 need not be aligned at an angle relative to the length of board 6.

FIG. 2 shows a side view of one embodiment of board 6 in which the curve of board 6 can be observed more readily. Board 6 has front end 10 and back end 11. Both front end 10 and back end 11 are curved slightly upward relative to the center of board 6 forming a substantially shallow and generally elongated U-shape. This shape aids in the aerodynamics of jumping by allowing less air resistance than a flat board. In addition, the curve of board 6 more closely conforms to the shape of the trampoline when in use and prevents the slapping of board 6 against the trampoline that might occur if the user lands on the trampoline unevenly (i.e., on one of the ends rather than the center of board 6). This could jostle the user and potentially lead to injury. However, one of ordinary skill will recognize that board 6 can be flat if the material selected to construct board 6 of is sufficiently flexible to account for this.

FIG. 2 also shows one manner in which securing members 7 can be tied to bottom surface 15 of board 6. However, one of ordinary skill in the art will readily appreciate that securing members 7 can be connected to board 6 by other means as disclosed supra. In this embodiment, securing members 7 are constructed of rubber, a rubber-like material, or some other sufficiently sturdy and flexible material. In an alternate embodiment, securing members 7 are constructed of the same material as non-slip gripping layer 8 on top surface 9 of board 6.

FIG. 3 shows board 6 in use. Specifically, FIG. 3 depicts user 12 using board 6, to simulate using a snowboard or a skateboard, on trampoline 13. As noted above, in the embodiment shown, the feet are kept in position by way of securing members 7 and heel securing members 14, allowing user 12 to engage in acrobatics on trampoline 13 without having to hold on to board 6.

1. A device for use on a trampoline comprising:
a board having a front end, and a back end, wherein said front end and said back end are each curved up from a horizontal plane of said trampoline; and
at least one securing member secured to said board, said at least one securing member adapted to receive a user's feet.

2. The device of claim 1, wherein said board is of a shape selected from a group comprised of generally ovular, generally circular, generally rectangular, generally hexagonal, and generally elliptical.

3. The device of claim 1, wherein said board is a substantially shallow and generally elongated U-shape.

4. The device of claim 1, wherein said board is made of a material selected from a group comprised of foam, . . .

5. The device of claim 1, wherein said board is made of a non-slip material.

6. The device of claim 1, wherein a non-slip layer is rigidly secured to said top surface.

7. The device of claim 1, wherein said at least one securing member is made of a material selected from a group comprised of a rubber, a rubber-like material, a plastic, a leather, a foam, and a nylon or other synthetic material.

8. The device of claim 1, wherein said at least one securing member further includes an adjustment mechanism.

9. The device of claim 8, wherein said adjustment mechanism is selected from a group comprised of a strap with a buckle, a stretchable material, and a hook-and-loop mechanism.

10. The device of claim 1, wherein said at least one securing member consists of a first securing member and a second securing member.

11. The device of claim 10, wherein said first securing member arranged in at an angle to said second securing member.

12. The device of claim 1, wherein said at least one securing member further includes at least one heel securing member.

13. The device of claim 12, wherein said at least one heel securing member further includes an adjustment mechanism.

14. The device of claim 12, wherein said at least one securing member and said at least one heel securing member are secured to said board by a mechanism selected from a group comprised of a screw, and a plurality of holes penetrating said board and said at least one securing member and said at least one heel securing member each penetrating one of said plurality of holes and being tied off in a knot at a bottom surface of said board.

15. The device of claim 14, wherein said bottom surface further includes a plurality of recesses to accommodate each of said screw or said knot.

16. The device of claim 6, wherein said non-slip layer has a plurality of holes, said board has a plurality of recesses, and each of said at least one securing member penetrates said plurality of holes of said non-slip layer and is secured to said board using a screw of being tied off in a knot, said knot or a protrusion of said screw being within one of said plurality of recesses within said board.

17. A device for use on a trampoline comprising:
a board having a top surface, a bottom surface, a front end, and a back end, wherein said front end and said back end are each curved up from a horizontal plane of said trampoline, forming a substantially shallow and generally elongated U-shape;
a non-slip layer rigidly securely to said top surface; and
two securing members attached to said board, each of said two securing members adapted to receive a user's foot.

18. The device for use on a trampoline of claim 17, wherein said board is of a shape selected from a group comprised of generally ovular, generally circular, generally rectangular, generally hexagonal, and generally elliptical.

19. The device for use on a trampoline of claim 17, wherein said board is made of a material selected from a group comprised of foam . . .

20. The device for use on a trampoline of claim 17, wherein said board is made of a non-slip material.

21. The device for use on a trampoline of claim 17, wherein each of said two securing members is made of a material selected from a group comprised of a rubber, a rubber-like material, a plastic, a leather, a foam, and a nylon or other synthetic material.

22. The device for use on a trampoline of claim 17, wherein each of said two securing members further includes an adjustment mechanism.

23. The device for use on a trampoline of claim 22, wherein said adjustment mechanism is selected from a group comprised of a strap with a buckle, a stretchable material, and a hook-and-loop mechanism.

24. The device for use on a trampoline of claim 17, wherein said two securing members are arranged in at an angle to one another.

25. The device for use on a trampoline of claim 17, wherein each of said two securing members further includes a heel securing member.

26. The device for use on a trampoline of claim 25, wherein each of said heel securing members further includes an adjustment mechanism.

27. The device for use on a trampoline of claim 25, wherein said at least one securing member and said at least one heel securing member are secured to said board by a mechanism selected from a group comprised of a screw, and a plurality of holes penetrating said board and said at least one securing member and said at least one heel securing member each penetrating one of said plurality of holes and being tied off in a knot at a bottom surface of said board.

28. The device for use on a trampoline of claim 27, wherein said bottom surface further includes a plurality of recesses to accommodate each of said screw or said knot.

29. The device for use on a trampoline of claim 17, wherein said non-slip layer has a plurality of holes, said board has a plurality of recesses, and each of said at least one securing member penetrates said plurality of holes of said non-slip layer and is secured to said board using a screw of being tied off in a knot, said knot or a protrusion of said screw being within one of said plurality of recesses within said board.

30. A device used for playing on a trampoline comprising:
a board having a top surface, a bottom surface, a front end, and a back end, wherein said front end and said back end are both curved upward from a horizontal plane of said trampoline, forming a substantially shallow and generally elongated U-shape;
a non-slip layer adhered to said top surface;
a first securing member adapted to receive a user's first foot, said first securing member penetrating through said top surface and attached to said board at said bottom surface; and
a second securing member adapted to receive a user's second foot, said second securing member penetrating through said top surface and attached to said board at said bottom surface.

31. The device used for playing on a trampoline of claim 30, wherein said board is of a shape selected from a group comprised of generally ovular, generally circular, generally rectangular, generally hexagonal, generally hexagonal, and generally elliptical.

32. The device used for playing on a trampoline of claim 30, wherein said board is made of a material selected from a group comprised of foam, . .

33. The device used for playing on a trampoline of claim 30, wherein said board is made of a non-slip material.

34. The device used for playing on a trampoline of claim 30, wherein said first securing member and said second securing member are made of a material selected from a group comprised of a rubber, a rubber-like material, a plastic, a leather, a foam, and a nylon or other synthetic material.

35. The device used for playing on a trampoline of claim 30, wherein said first securing member and said second securing member further include an adjustment mechanism.

36. The device used for playing on a trampoline of claim 35, wherein said adjustment mechanism is selected from a group comprised of a strap with a buckle, a stretchable material, and a hook-and-loop mechanism.

37. The device used for playing on a trampoline of claim 30, wherein said first securing member and said second securing member are arranged in at an angle to one another.

38. The device used for playing on a trampoline of claim 30, wherein said first securing member and said second securing member each further include a heel securing member.

39. The device used for playing on a trampoline of claim 38, wherein each of said heel securing members further include an adjustment mechanism.

40. The device used for playing on a trampoline of claim 38, wherein each of said heel securing members are secured to said board by a mechanism selected from a group comprised of a screw, and a plurality of holes penetrating said board with each of said heel securing members penetrating one of said plurality of holes and being tied off in a knot at a bottom surface of said board.

41. The device used for playing on a trampoline of claim 40, wherein said bottom surface further includes a plurality of recesses to accommodate each of said screw or said knot.

42. The device used for playing on a trampoline of claim 30, wherein said non-slip layer has a plurality of holes, said board has a plurality of recesses, and each of said at least one securing member penetrates said plurality of holes of said non-slip layer and is secured to said board using a screw of being tied off in a knot, said knot or a protrusion of said screw being within one of said plurality of recesses within said board.
